(19) United States
(12) Patent Application Publication
(10) Pub. No.: US 2022/0060209 A1
(43) Pub. Date: Feb. 24, 2022

(54) MOBILE DEVICE HOLDER

(71) Applicant: Adetokunbo Balogun, Upper Marlboro, MD (US)

(72) Inventor: Adetokunbo Balogun, Upper Marlboro, MD (US)

(21) Appl. No.: 17/505,146

(22) Filed: Oct. 19, 2021

Related U.S. Application Data
(60) Provisional application No. 63/067,750, filed on Aug. 19, 2020.

(51) Int. Cl. H04B 1/3877; F16M 11/04; F16M 11/12

(52) U.S. Cl. CPC H04B 1/3877; F16M 11/123; F16M 11/041

(57) ABSTRACT

A mobile device holder that can be used to mount mobile electronic devices, such as a smartphone to the thigh of a user. The mobile device holder includes a wrap member that wraps and secures to the thigh. A mounting member coupled to the wrap member, an elongated shaft removably mounted to the mounting member, two or more gimbals connect a gripper to the shaft. the gripper can clamp the mobile electronic device, wherein the shaft and the gimbals can be maneuvered for the desired view angle.

### CROSS-REFERENCE TO RELATED APPLICATIONS

This application claims priority from the U.S. provisional patent application Ser. No. 63/067,750, filed on Aug. 19, 2020, which is incorporated herein by reference in its entirety.

### FIELD OF INVENTION

The present invention relates to a holder for mobile electronic devices, and more particularly, the present invention relates to a mobile device holder that can be mounted to a body part and can provide for the hands-free operation of a mobile electronic device, such as a smartphone.

### BACKGROUND

Mobile phones have been used for communications including voice calls and text messages. However, in modern times, mobile phones are a multipurpose device and an essential part of human lives. Mobile phones, also popularly known as smartphones, allow users to do video calls, watch videos, play games, listen to music, and do a range of utility and entertainment activities. Like a smartphone, many handheld computing devices, such as tablet computers, video players, and like are also available for entertainment as well as for work.

Smartphones and mobile electronic devices have to be held in the hand and facing the face to interact, such as watching videos or having video calls. Holding the mobile electronic device in the hand for a long duration not only keeps the hand busy but also leads to pain and injury.

Mobile phone holders are commercially available that allow mobile electronic devices to be held on tables and view angles of the mobile phone can be adjusted by the users. However, keeping the mobile phone on a table or similar platform is often not comfortable. The primary drawback of known mobile holders is that the user has limited body movements while watching or interacting with the mobile phone. Thus, a need is appreciated for a mobile device holder that is more comfortable and provides a better user experience.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a mobile device holder that can be mounted to a body part.

It is another object of the present invention that the mobile device holder can be mounted to the thigh of the user.

It is still another object of the present invention that the mobile device holder can be adapted to variable sizes of thighs.

It is yet another object of the present invention that the mobile device holder is versatile by allowing a wide range of viewing angles.

It is a further object of the present invention that the user can enjoy the hands-free operation of the mobile device.

It is still a further object of the present invention that the user can change body posture, sit, lie down, or walk while being occupied with the mobile device.

It is yet a further object of the present invention that the mobile device holder can allow charging the mobile electronic device.

In one aspect, disclosed is a mobile device holder that can be used to mount a smartphone, small size tablet computers, handheld video players, and like mobile electronic devices. The mobile device holder can itself be mounted to a body part of the user, and preferably to the thigh of the user. The mobile device holder can include a wrap member that can be wrapped around the body part, such as the thigh, leg, or waist. A mounting member coupled to the wrap member, an elongated shaft removably mounted to the mounting member, two or more gimbals connect a gripper to the shaft.

In one aspect, the gripper can allow clamping of the mobile electronic device. The gripper can be adapted to different sizes and shapes of mobile electronic devices.

In one aspect, the two or more gimbals may permit multiple axes of rotation for the mobile device coupled to the gripper.

In one aspect, the shaft can be semi-right that flexes under an external force but maintains rigidity under the weight of the mobile electronic device.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a mobile device holder, according to an exemplary embodiment of the present invention.

FIG. 2 shows the three gimbals and a gripper of the mobile device holder, according to an exemplary embodiment of the present invention.

FIG. 3 shows the smartphone clamped to the gripper, according to an exemplary embodiment of the present invention.

FIG. 4 shows a feature of the gripper that allows adapting to mobile electronic devices of different sizes, according to an exemplary embodiment of the present invention.

FIG. 5 shows a wrap member and a mounting member of the mobile device holder, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a mobile device holder that can be used for the hands-free operation of mobile electronic devices, such as smartphones, tablet computers, video players, speakerphones, audio players, and cameras. The disclosed mobile device holder can be mounted to a body part of a user, such as a thigh, and can hold the mobile electronic device for the user. The mobile device holder is versatile by allowing the user to adjust the view angle of the mobile electronic device clamped to the disclosed mobile device holder in a number of ways. The versatility of the mobile device holder allows the user to keep engaged with the mobile device and freely change the body posture, lie down, or walk. The user can easily jerk off any muscle fatigue built up by stretching the muscles while watching a video on the mobile electronic device. The user can easily maintain the desired distance between the eyes and the mobile electronic device. Moreover, the user can easily bring the mobile device closer and farther without any compromise with the view angle. The user can engage with the mobile device held by the mobile device holder while sitting, walking, and laying. The hands of the user are free to engage in any other task, such as the user can have dinner while watching a video. The user can enjoy long video conferences or movies without pain in the hands. The user can easily move and relax while interacting with the mobile device.

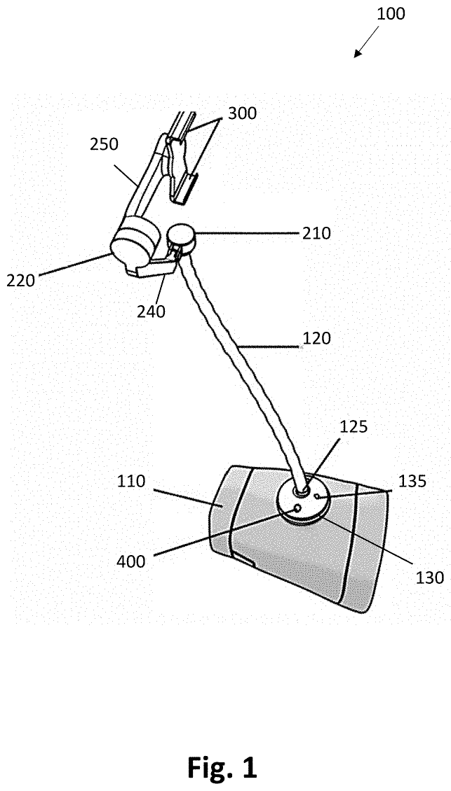

Referring to FIG. 1 which is a perspective view of the mobile device holder 100. The mobile device holder 100 can include a wrap member 110 which can be in the form of a strap or belt that can be firmly wrapped around a body part of the user. Preferably, the body part can be the thigh, either the left thigh or right thigh. However, other body parts, such as the leg and waist are within the scope of the present invention. The wrap member can have a fastener for tightening and securing the wrap member 110 over the thigh. In one case, the fastener can be a hook and loop fastener that may also allow adjusting an effective length of the wrap member. Preferably, the wrap member can be adapted to different sizes of thighs. The wrap member can be made from a durable and flexible material, such as Nylon. A mounting member 130 can also be seen coupled to the wrap member 110. The mounting member 130 provides an attachment point for the shaft 120. The mounting member can be fixedly bonded to the wrap member 110 or can be removably attached to the wrap member 110.

The shaft 120 can be of an elongated rod shape geometry and semi-rigid in construction. The shaft 120 can flex under an external force to allow changing the position of the mobile electronic device. The shaft 120 can be semi-rigid that bends under an external force but maintains the shape or rigidity under the weight of the mobile electronic device. The shaft 120 can be removably installed in the mounting member, such as the user can remove the shaft as and when desired from the mounting member. In one case, an end of the shaft 120 can snap-fit into a groove 125 of the mounting member 130. A release button 135 can also be provided in the mounting member 130, wherein actuation of the release button 135 can release the shaft 120 from the mounting member 130. Thus, a user desiring to temporarily take off the mobile device holder 100 can remove the shaft 120 from the mounting member 130 rather than completely removing the holder i.e., remove the wrap member 110 from the thigh.

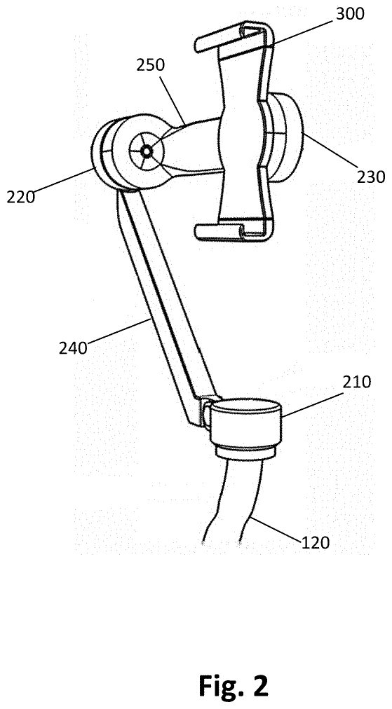

The other end of the shaft 120 can be coupled to a set of gimbals. The gimbals may provide for multiple axes of rotation. FIG. 2 shows a first gimbal 210 coupled to the end of the shaft 120. A second gimbal 220 can be coupled to the first gimbal 210 through a first extension 240. A third gimbal 230 can be coupled to the second gimbal 220 through a second extension 250. The three gimbals can provide for multiple axes of rotation of the gripper 300. The gripper 300 can be seen coupled to the third gimbal 230 wherein the gripper can be maneuvered to desired viewing angle. The semi-rigid shaft and the set of gimbals can make the disclosed mobile device holder versatile that can be adjusted in multiple ways for the desired viewing angle.

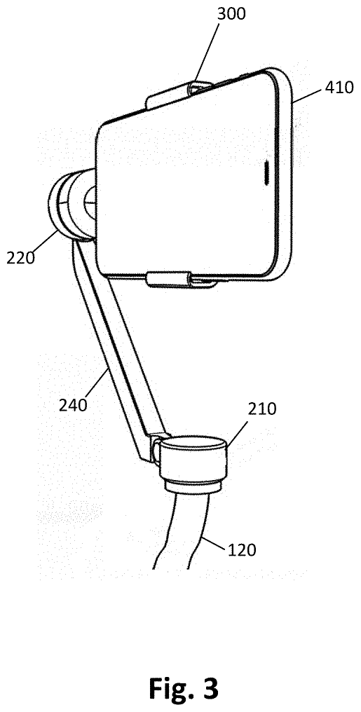

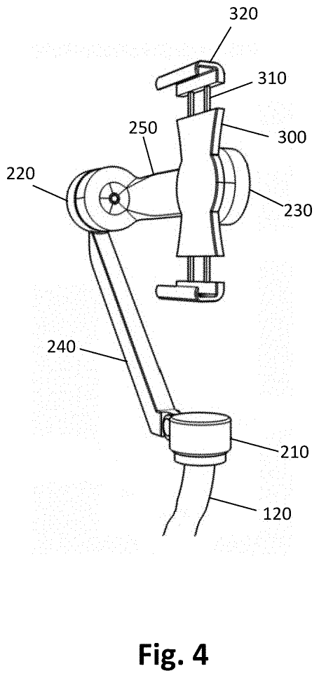

Referring to FIG. 3, the gripper 300 can clamp a mobile electronic device 410. The mobile electronic device 410 shown in FIG. 3 is a smartphone. The mobile electronic device 410 can be gripped by the gripper and the view angle of the mobile electronic device 410 can be adjusted to the desired angle by adjusting the shaft and the gimbals. An exemplary embodiment of the gripper 300 is shown in FIG. 4. The gripper can include a pair of jaws 320 extended through resilient members 310. The pair of jaws 320 can clamp the mobile electronic device while the resilient members 310 can allow clamping the mobile electronic devices of different sizes.

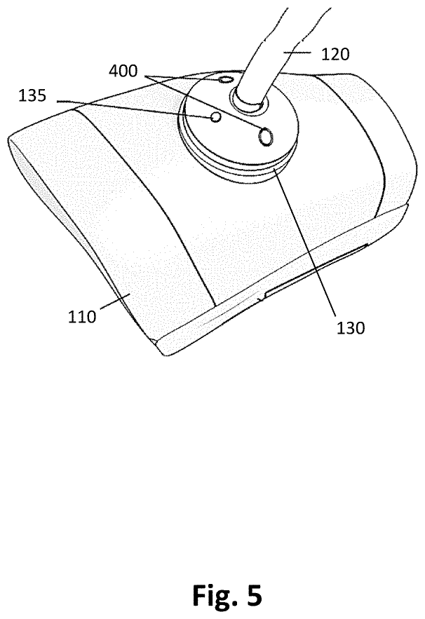

FIG. 5 shows an enlarged view of the wrapping member 110. The wrapping member can be seen as a loop that can be wrapped around the thigh or other body parts. The mounting member 130 can include control buttons 400. The control buttons 400 can be used to control one or more functions, such as trigger of the camera, or take a snapshot. The control buttons can be wired or wirelessly connected to the mobile electronic device, such as Bluetooth® or Wi-Fi. Different functions can also be assigned to the control buttons.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A mobile device holder comprising:
a wrap member configured to be wrapped around and secure to a body part of a user;
a mounting member fixedly coupled to the wrap member, the mounting member comprises an attachment point;
an elongated shaft, the elongated shaft has a proximal end and a distal end, the proximal end of the elongated shaft mounted to the attachment point;
a plurality of gimbals coupled to the distal end of the elongated shaft; and
a gripper coupled to the plurality of the gimbals, the gripper configured to clamp a mobile electronic device, wherein the plurality of gimbals provides for multiple axes of rotation of the gripper.

2. The mobile device holder according to claim 1, wherein the body part is a thigh of the user.

3. The mobile device holder according to claim 1, wherein the wrap member comprises a fastener for securing the wrap member to the body part.

4. The mobile device holder according to claim 3, wherein the fastener is a hook and loop fastener.

5. The mobile device holder according to claim 1, wherein the mounting member further comprises a release button, the release button configured to be actuated for releasing the proximal end of the elongated shaft from the attachment point.

6. The mobile device holder according to claim 1, wherein the mounting member further comprises one or more control buttons configured to operably couple to the mobile electronic device, wherein the one or more control buttons configured to trigger one or more functions of the mobile electronic device.

7. The mobile device holder according to claim 6, wherein the one or more control buttons are configured to wirelessly connect to the mobile electronic device.

8. The mobile device holder according to claim 7, wherein the one or more control buttons are configured to connect to the mobile electronic device through Bluetooth®.

9. The mobile device holder according to claim 1, wherein the elongated shaft is of a tubular geometry and semi-solid construction, wherein the elongated shaft can bend under an external force but maintains shape or rigidity under a weight of the mobile electronic device.

10. The mobile device holder according to claim 1, wherein a first gimbal of the plurality of gimbals is coupled to the distal end of the elongated shaft, a second gimbal of the plurality of gimbals coupled to the first gimbal through a first extension, and a third gimbal of the plurality of gimbals is coupled to the second gimbal through a second extension, the third gimbal coupled to the gripper.

11. The mobile device holder according to claim 1, wherein the gripper comprises a pair of jaws for clamping the mobile electronic device, the pair of jaws extended through resilient members.

12. The mobile device holder according to claim 1, wherein the mobile electronic device is a smartphone.
